(19) United States
(12) Patent Application Publication
(10) Pub. No.: US 2026/0094845 A1
(43) Pub. Date: Apr. 2, 2026

(54) ELECTRODE FOR FUEL CELL WITH PREVENTED IONOMER POISONING OF CATALYST AND REDUCED ELUTION AND METHOD OF MANUFACTURING SAME

(71) Applicants: Hyundai Motor Company, Seoul (KR); Kia Corporation, Seoul (KR)

(72) Inventors: Il Seok Chae, Hwaseong (KR); Seong Hun Cho, Hwaseong (KR); Sang Jin Han, Hwaseong (KR)

(21) Appl. No.: 19/174,681

(22) Filed: Apr. 9, 2025

(30) Foreign Application Priority Data
Oct. 2, 2024 (KR) 10-2024-0133495

(51) Int. Cl. H01M 4/86; H01M 4/88; H01M 4/92

(52) U.S. Cl. CPC H01M 4/8605; H01M 4/8668; H01M 4/8828; H01M 4/926

(57) ABSTRACT

An electrode for a fuel cell comprises an electrode binder and an electrode catalyst dispersed therein. The electrode catalyst includes a catalyst complex with a catalytic metal supported on a support and a porous polymer coating layer. The porous polymer enhances performance by forming a core-shell structure on the catalytic metal surface. A method of manufacturing the electrode includes involving preparation of the catalyst complex, coating the catalytic metal with the porous polymer to form an electrode catalyst, combining the catalyst with an electrode binder to prepare a slurry, and applying the slurry onto a substrate. The porous polymer is optionally a polymer of intrinsic microporosity (PIM) or a copolymer, with molecular weight, composition, and thickness optimized for conductivity and performance. The electrode is suitable for use in a membrane-electrode assembly for fuel cells.

### CROSS-REFERENCE TO RELATED APPLICATION

This application claims, under 35 U.S.C. § 119 (a), the benefit of Korean Patent Application No. 10-2024-0133495, filed on Oct. 2, 2024, the entire contents of which are incorporated herein by reference.

### BACKGROUND

### Technical Field

The present disclosure relates to an electrode for a fuel cell and a method of manufacturing the same, in which a coating layer of an electrode catalyst having a core-shell structure includes a porous polymer, thereby preventing ionomer poisoning of the catalyst and reducing elution.

### Background

A proton exchange membrane fuel cell (PEMFC or polymer electrolyte membrane fuel cell) is a power generation device using hydrogen fuel and offers advantages such as high energy efficiency, simple system configuration, and being environmentally friendly. Proton exchange membrane fuel cells have recently gained attention as energy conversion devices for environmentally friendly automobiles.

The power generation reaction in a fuel cell occurs within a membrane-electrode assembly (MEA) comprising a perfluorinated sulfonic acid (PFSA) ionomer-based membrane and anode/cathode electrodes. When hydrogen is supplied to the anode, the oxidation electrode of the fuel cell, it is split into protons and electrons. The protons move to the cathode, which is the reduction electrode, through a membrane, and the electrons move to the cathode through an external circuit. At the cathode, oxygen molecules, protons, and electrons combine to generate power and heat, with water (H₂O) produced as a reaction byproduct.

Fuel cell performance is significantly hindered by the high overpotential (up to 300-400 mV) of the oxygen reduction reaction (ORR) at the cathode. Current research and development of fuel cell catalysts have primarily focused on enhancing the specific activity of platinum catalysts, etc. supported on carbon supports. However, a critical issue is that Pt nanoparticles (NPs) are susceptible to activity degradation in harsh electrochemical environments, including poisoning by ionomers contained in the electrode.

### SUMMARY

The present disclosure has been made keeping in mind the problems encountered in the related art, and an object of the present disclosure is to provide an electrode for a fuel cell capable of effectively protecting a catalytic metal from a catalyst poisoning agent in an oxidizing electrochemical environment by applying a predetermined shell or coating layer onto the surface of the catalytic metal.

Another object of the present disclosure is to provide an electrode catalyst capable of maintaining high oxygen permeability and proton transportability by controlling the material, oxygen permeability, thickness, etc. of the coating layer, and an electrode for a fuel cell including the electrode catalyst.

Still another object of the present disclosure is intended to provide a method of manufacturing an electrode for a fuel cell including the catalyst having such a structure in a simpler manner.

The objects of the present disclosure are not limited to the foregoing. The objects of the present disclosure will be able to be clearly understood through the following description and to be realized by the means described in the claims and combinations thereof.

In one aspect, an electrode for a fuel cell is provided that comprises a) an electrode binder and b) an electrode catalyst admixed with electrode binder, wherein the electrode catalyst comprises a catalyst complex comprising a catalytic metal supported on a support and a coating layer comprising a porous polymer on at least a portion of the surface of the catalytic metal.

An embodiment of the present disclosure provides an electrode for a fuel cell, including an electrode binder and an electrode catalyst dispersed in the electrode binder, in which the electrode catalyst includes a catalyst complex including a catalytic metal supported on a support and a coating layer formed by coating at least a portion of the surface of the catalytic metal with a porous polymer.

In one embodiment, the electrode binder may include a perfluorinated sulfonic acid polymer.

In one embodiment, the catalytic metal may include one or more of platinum, palladium, cobalt, gold, ruthenium, tin, molybdenum, rhodium, iridium, bismuth, copper, yttrium, and chromium.

In one embodiment, the support may include a carbon-based support, and the carbon-based support may include one or more of carbon black, carbon nanotubes, graphite, and graphene.

In one embodiment, the porous polymer may include a polymer of intrinsic microporosity (PIM).

Also, the porous polymer may include a copolymer of any one of monomers A1 to A18 below and any one of monomers B1 to B19 below.

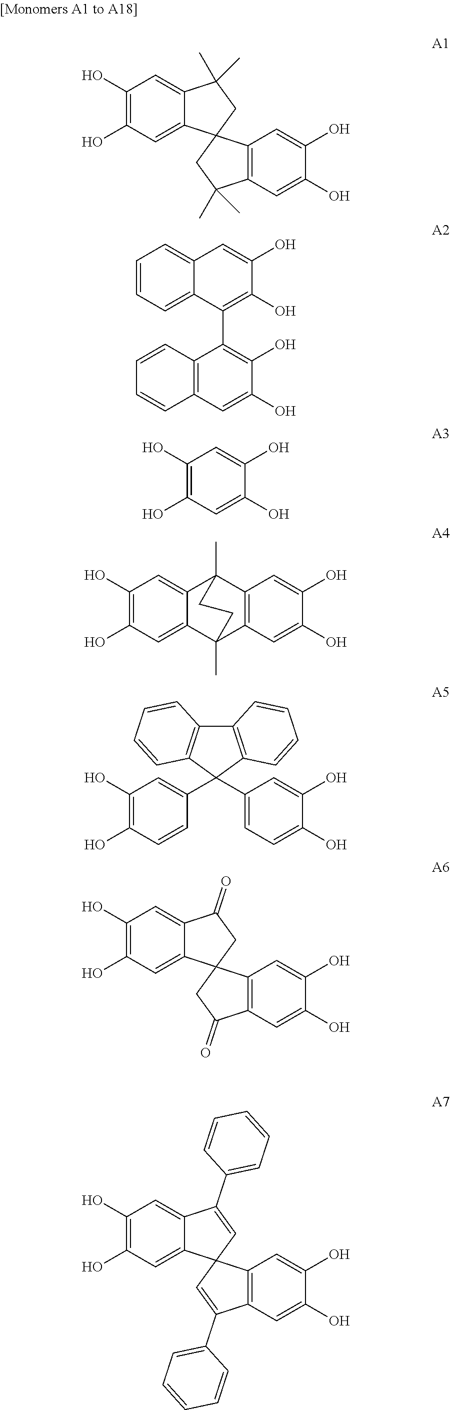

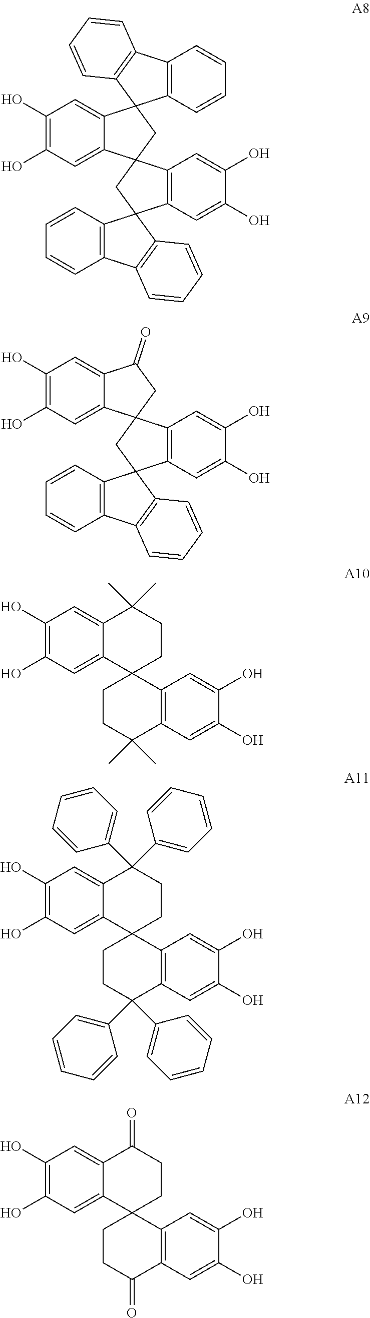

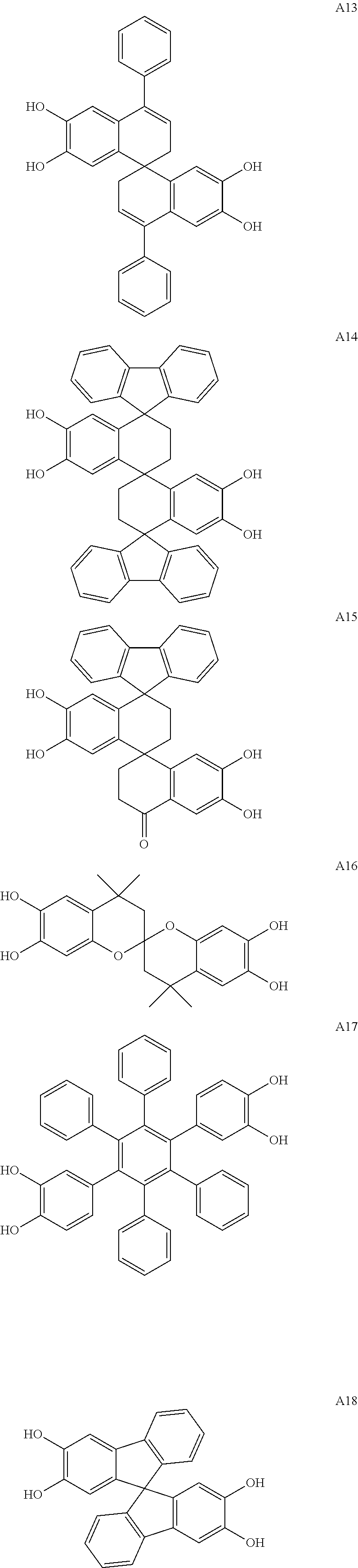

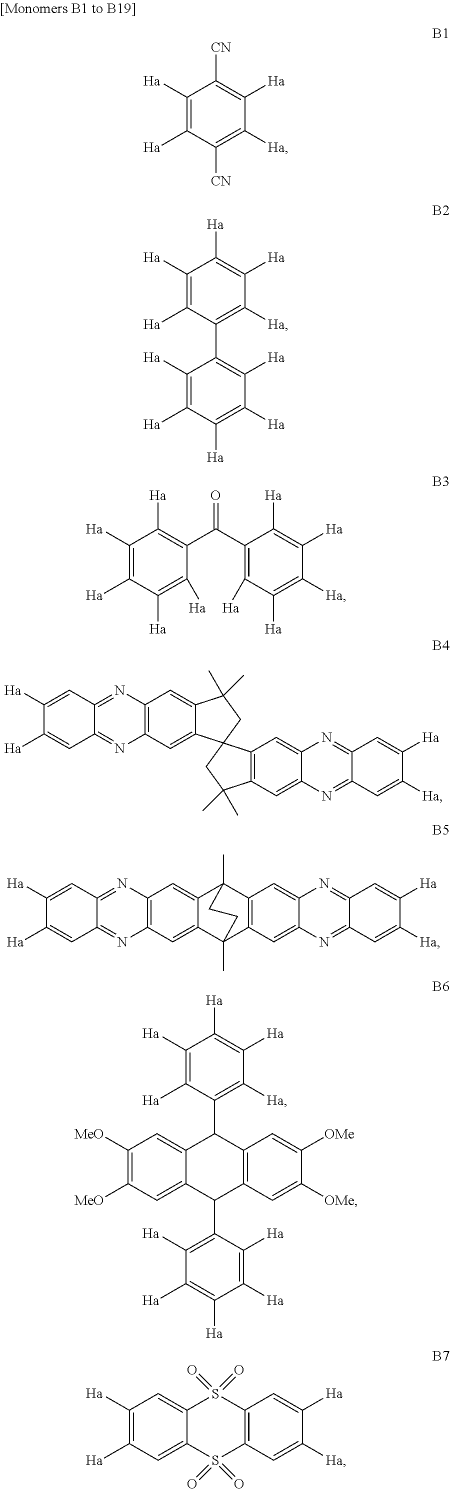

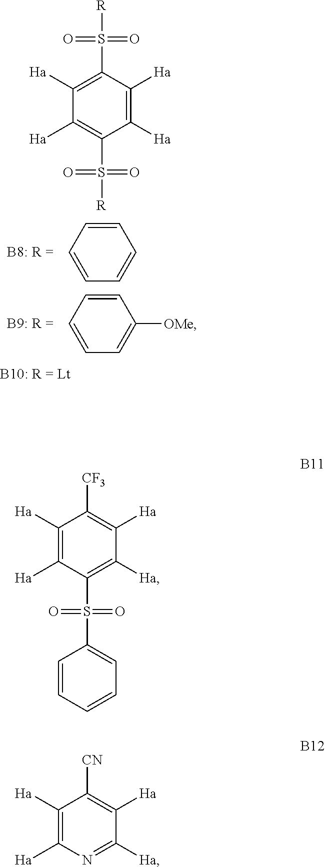

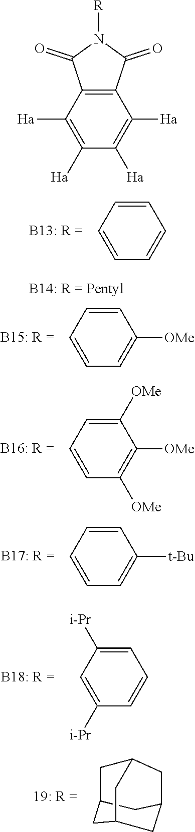

Here. Ha may include one or more of F, Cl, Br, and I.

In one embodiment, the porous polymer may be represented by Chemical Formula 1 below.

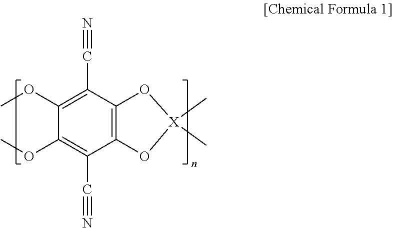

Here, X includes one or more of

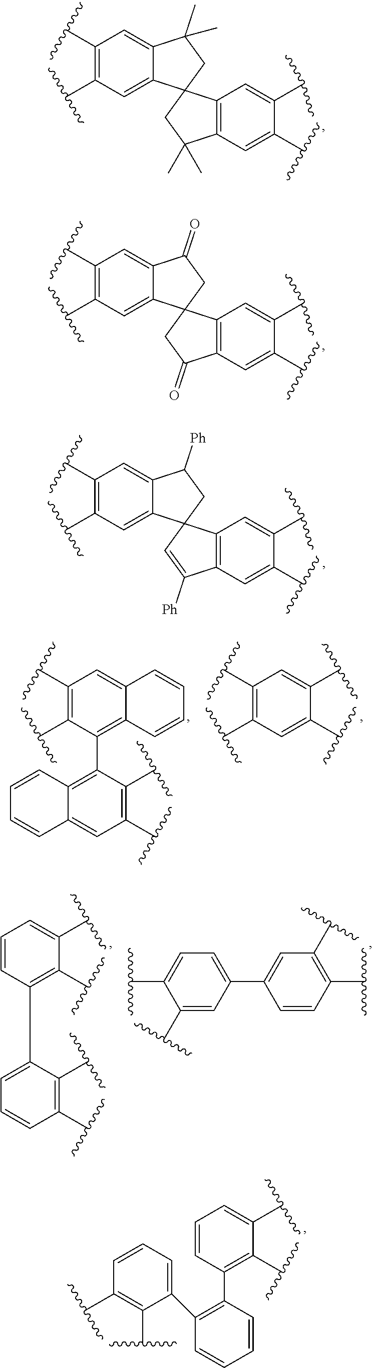

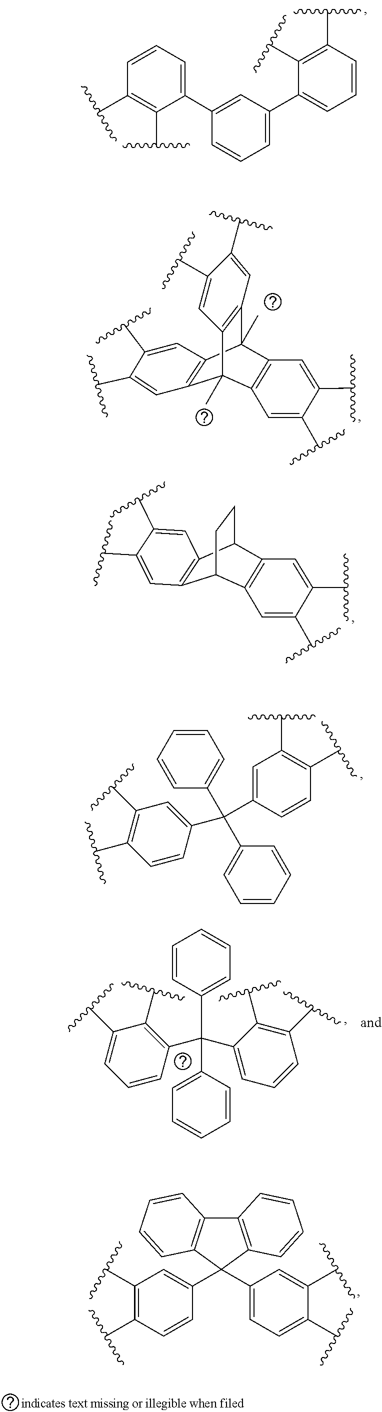

and n is an integer from 1 to 10.

In one embodiment, the coating layer may include a porous polymer having a number average molecular weight (Mn) of 5,000 to 100,000.

In one embodiment, the weight ratio of the catalyst complex to the porous polymer in the coating layer may be 100:3 to 100:20.

In one embodiment, the thickness of the coating layer may be 0.1 nm to 5 nm.

Another embodiment of the present disclosure provides a membrane-electrode assembly, including an electrolyte membrane, a cathode formed on one side of the electrolyte membrane, and an anode formed on the other side of the electrolyte membrane, in which at least one of the cathode and the anode includes the electrode described above.

Still another embodiment of the present disclosure provides a method of manufacturing an electrode for a fuel cell, including preparing a catalyst complex including a support, a catalytic metal and a porous polymer, manufacturing an electrode catalyst with a core-shell structure by coating at least a portion of the surface of the catalytic metal with the porous polymer, preparing a slurry by combining the electrode catalyst with an electrode binder, and forming an electrode by applying the slurry onto a substrate.

Here, manufacturing the electrode catalyst may include adding the catalyst complex and the porous polymer to a solvent followed by mixing, precipitating and recovering the electrode catalyst by pouring an aqueous solvent into the mixture, and drying the recovered electrode catalyst.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows a portion of an electrode according to the present disclosure;

FIG. 2 shows a membrane-electrode assembly according to the present disclosure;

FIG. 3 shows a transmission electron microscope image of an electrode catalyst according to Preparation Example 1;

FIG. 4 shows a transmission electron microscope image of an electrode catalyst according to Preparation Example 2;

FIG. 5 shows a transmission electron microscope image of an electrode catalyst according to Preparation Example 3;

FIG. 6 shows a portion of the image of FIG. 3 where energy dispersive spectroscopy (EDS) is performed and an enlarged view thereof;

FIG. 7 shows results of line scan of the portion shown in FIG. 6 using energy dispersive spectroscopy (EDS);

FIG. 8 shows results of BOL and EOL performance of a membrane-electrode assembly according to Example 1; and

FIG. 9 shows results of BOL, EOL 10K, and EOL 50K of a membrane-electrode assembly according to Example 2.

### DETAILED DESCRIPTION OF SPECIFIC EMBODIMENTS

The above and other objects, features and advantages of the present disclosure will be more clearly understood from the following preferred embodiments taken in conjunction with the accompanying drawings. However, the present disclosure is not limited to the embodiments disclosed herein and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

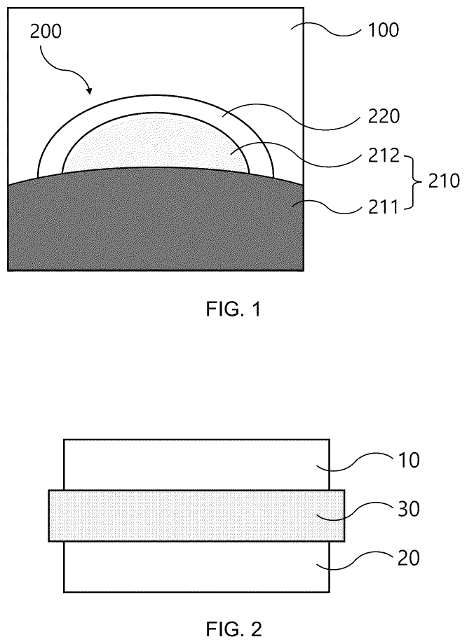

FIG. 1 shows a portion of an electrode according to the present disclosure. An electrode for a fuel cell according to an embodiment of the present disclosure includes an electrode binder 100 and an electrode catalyst 200 dispersed in the electrode binder 100. In the electrode for a fuel cell, the electrode catalyst 200 may include a catalyst complex 210 having a catalytic metal 212 supported on a support 211 and a coating layer 220 formed by coating at least a portion of the surface of the catalytic metal 212 with a porous polymer. Specifically, the electrode catalyst may be configured such that a core-shell catalyst including a core containing a catalytic metal 212 and a shell 220 in which at least a portion of the surface of the catalytic metal 212 is coated with a porous polymer is supported on the support 211.

In the present disclosure, it is possible to prevent the catalytic metal 212 from being poisoned by an ionomer by enhancing hydrophobicity through a core-shell structure in which the surface of the catalytic metal 212 is coated with a porous polymer, and to drastically reduce deterioration in catalytic performance caused by elution of the catalytic metal 212, such as platinum, outside the electrode.

In one embodiment, the electrode binder 100 may include a perfluorinated sulfonic acid polymer, for example Nafion.

In one embodiment, the catalytic metal 212 may include any one selected from the group consisting of platinum, palladium, cobalt, gold, ruthenium, tin, molybdenum, rhodium, iridium, bismuth, copper, yttrium, chromium, and combinations thereof. Here, the combination thereof means alloying of metal elements. Preferably, platinum or a platinum alloy is used as the catalytic metal 212.

In one embodiment, the catalyst complex may include a support 211 and a catalytic metal 212 supported on the support 211, as shown in FIG. 1. The support 211 may play a role in enlarging the active area of the catalytic metal 212 and improving stability by supporting the catalytic metal 212 on the surface thereof.

The support 211 is not particularly limited so long as it is commonly used in the art, and may include, for example, a carbon-based support. The carbon-based support may include any one selected from the group consisting of carbon black, carbon nanotubes, graphite, graphene, and combinations thereof. The carbon black may include acetylene black, Denka black, Ketjen black, etc.

When using, as the electrode catalyst, the catalyst complex in which the catalytic metal 212 is supported on the support 211, a coating layer 220 may be formed by coating the surface of the catalytic metal 212 with the porous polymer. This may be because functional groups such as —CN groups, etc. contained in the porous polymer have an electron withdrawing effect and thus preferentially bind to the relatively electron-rich catalytic metal 212 due to this effect.

In one embodiment, the porous polymer may include a polymer of intrinsic microporosity (PIM). It is known that PIMs are composed of rigid and highly distorted polymer backbones, making it difficult to form a close-packed structure in solid phase and forming micropores in an amorphous structure due to inefficient stacking. Accordingly, PIMs have high oxygen gas permeability and high fractional free volume.

Moreover, although a PIM is not an ionomer, it may exhibit appropriate proton conductivity by transporting protons together with an aqueous solvent such as water within intrinsic micropores thereof.

The electrode catalyst 200 according to the present disclosure has a core-shell structure formed by coating the surface of the catalytic metal 212 with a PIM, thereby effectively protecting the catalytic metal 212 from a catalyst poisoning agent in an oxidizing electrochemical environment and also maintaining high oxygen permeability and proton transportability through the coating layer 220. Furthermore, the PIM has high affinity for the catalytic metal 212 such as platinum, etc., and thus may be uniformly applied onto the surface of the catalytic metal 212.

As a non-limiting example, the PIM according to the present disclosure may be represented by Chemical Formula 1 below.

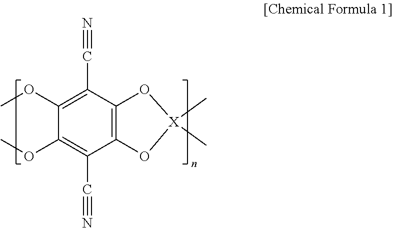

Here, X includes at least one selected from the group consisting of

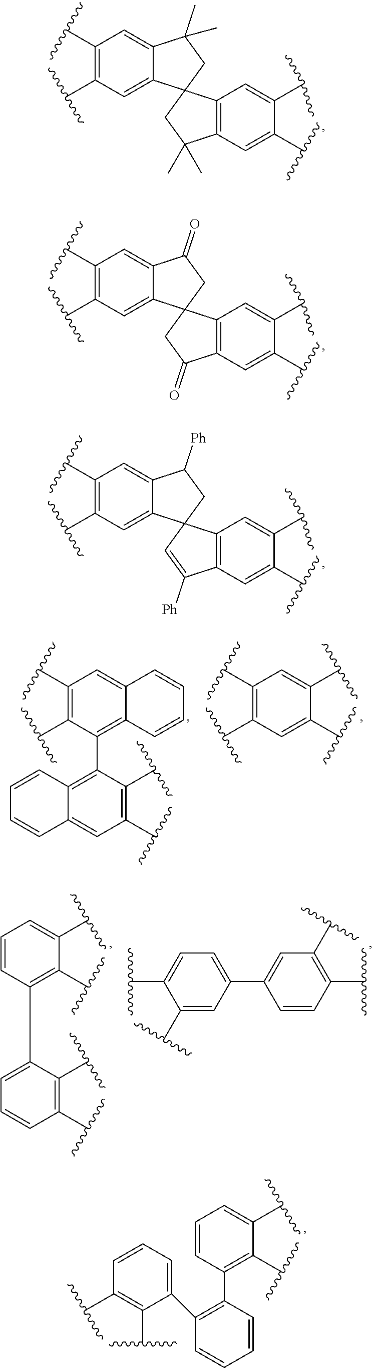

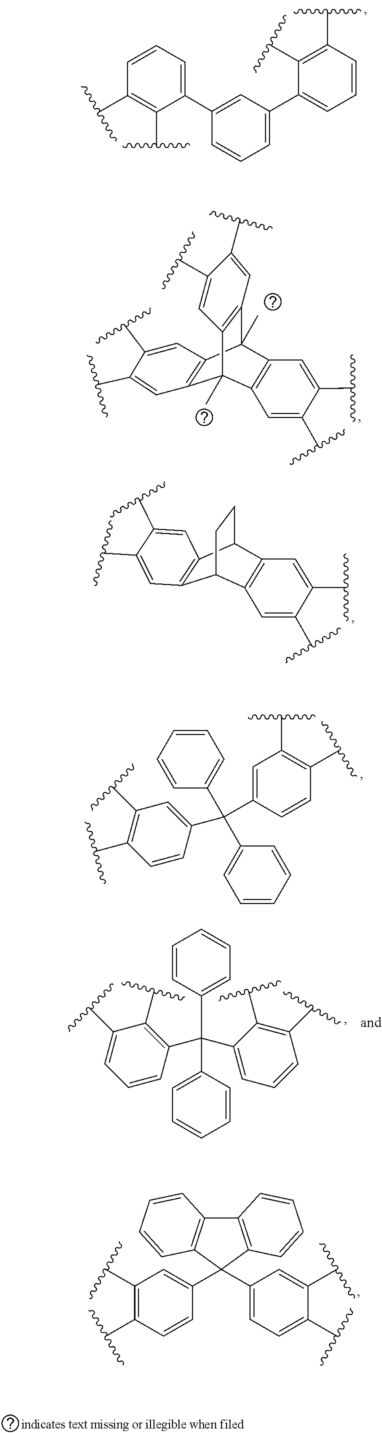

and n is an integer from 1 to 10 or an integer from 6 to 7.

In addition, the type of PIM according to the present disclosure may include a copolymer of at least one of monomers A1 to A18 below and at least one of monomers B1 to B19 below.

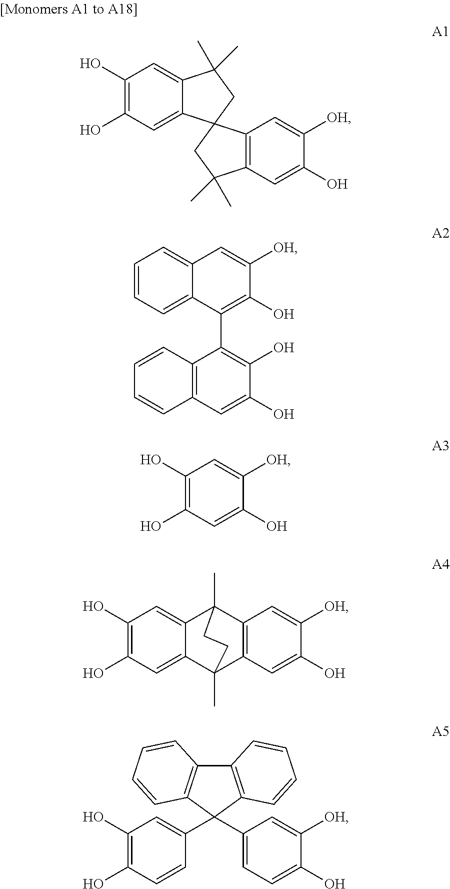

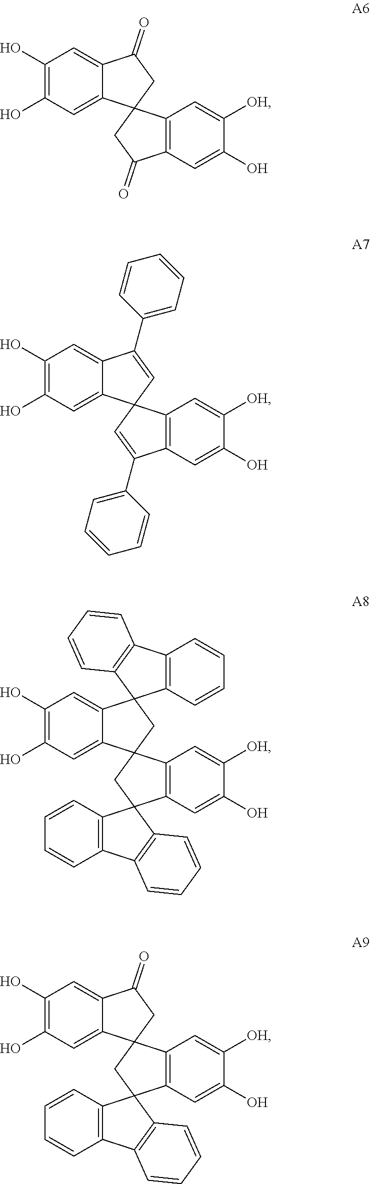 [SMILES: O=C1CC2(CC(=O)c3cc(O)c(O)cc32)c2cc(O)c(O)cc21 ; Oc1cc2c(cc1O)C1(C=C2c2ccccc2)C=C(c2ccccc2)c2cc(O)c(O)cc21 ; Oc1cc2c(cc1O)C1(CC23CC2(c4ccccc4-c4ccccc42)c2cc(O)c(O)cc23)c2ccccc2-c2ccccc21 ; O=C1CC2(CC3(c4ccccc4-c4ccccc43)c3cc(O)c(O)cc32)c2cc(O)c(O)cc21]

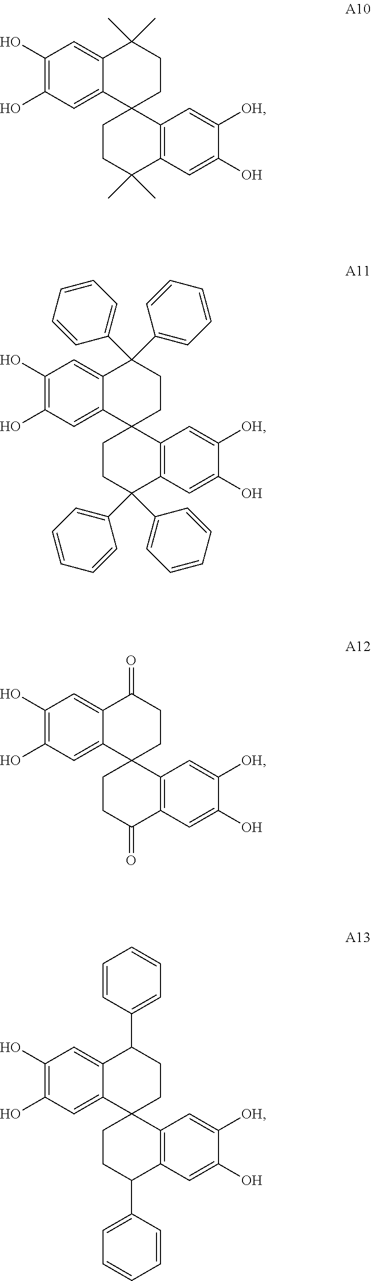 [SMILES: CC1(C)CCC2(CCC(C)(C)c3cc(O)c(O)cc32)c2cc(O)c(O)cc21 ; Oc1cc2c(cc1O)C(c1ccccc1)(c1ccccc1)CCC21CCC(c2ccccc2)(c2ccccc2)c2cc(O)c(O)cc21 ; O=C1CCC2(CCC(=O)c3cc(O)c(O)cc32)c2cc(O)c(O)cc21 ; Oc1cc2c(cc1O)C1(CCC2c2ccccc2)CCC(c2ccccc2)c2cc(O)c(O)cc21]

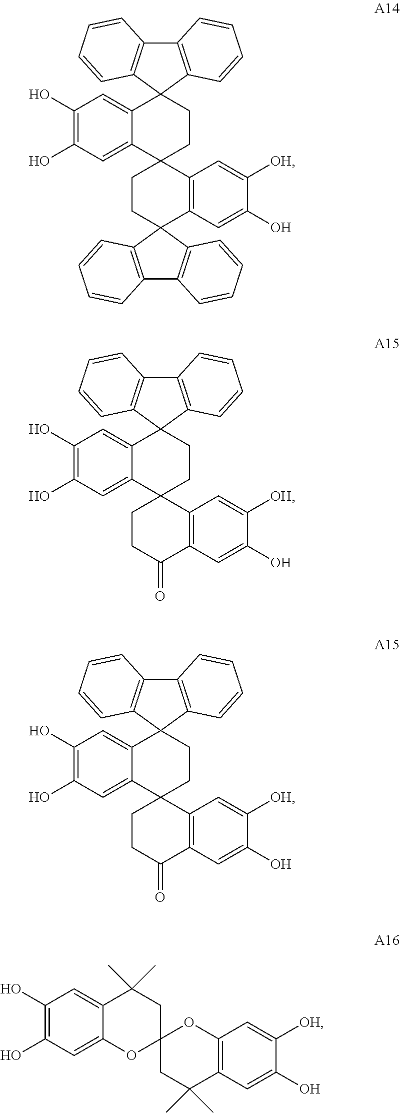

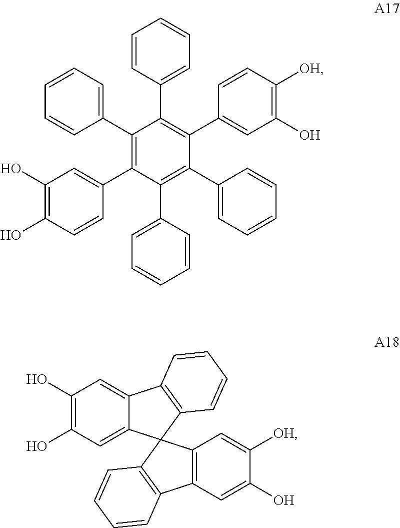 [SMILES: Oc1ccc(-c2c(-c3ccccc3)c(-c3ccccc3)c(-c3ccc(O)c(O)c3)c(-c3ccccc3)c2-c2ccccc2)cc1O ; Oc1cc2c(cc1O)C1(c3ccccc3-2)c2ccccc2-c2cc(O)c(O)cc21]

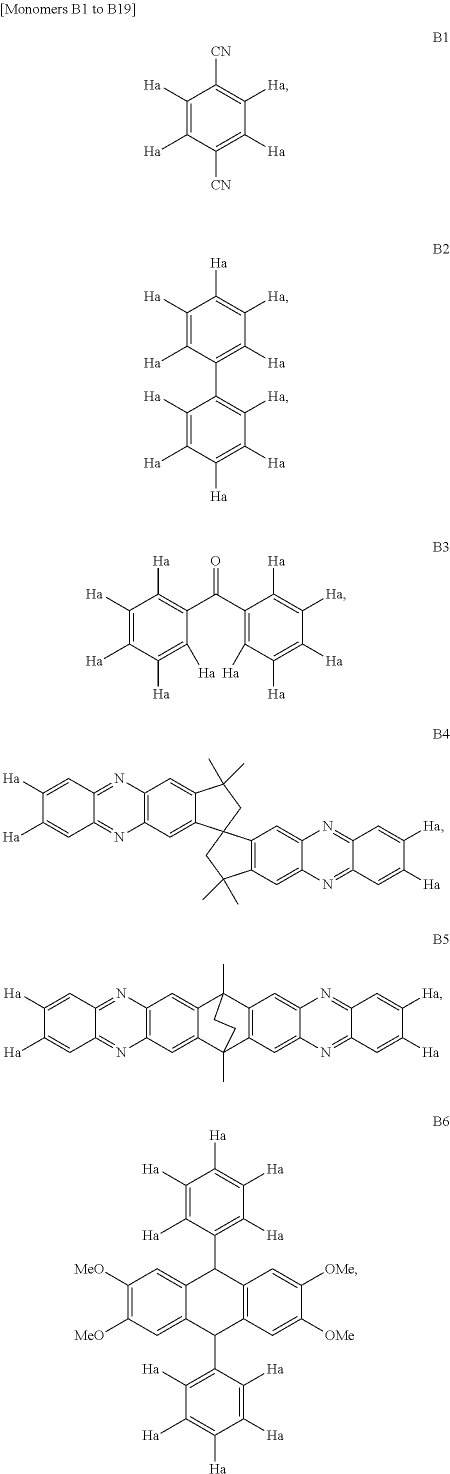

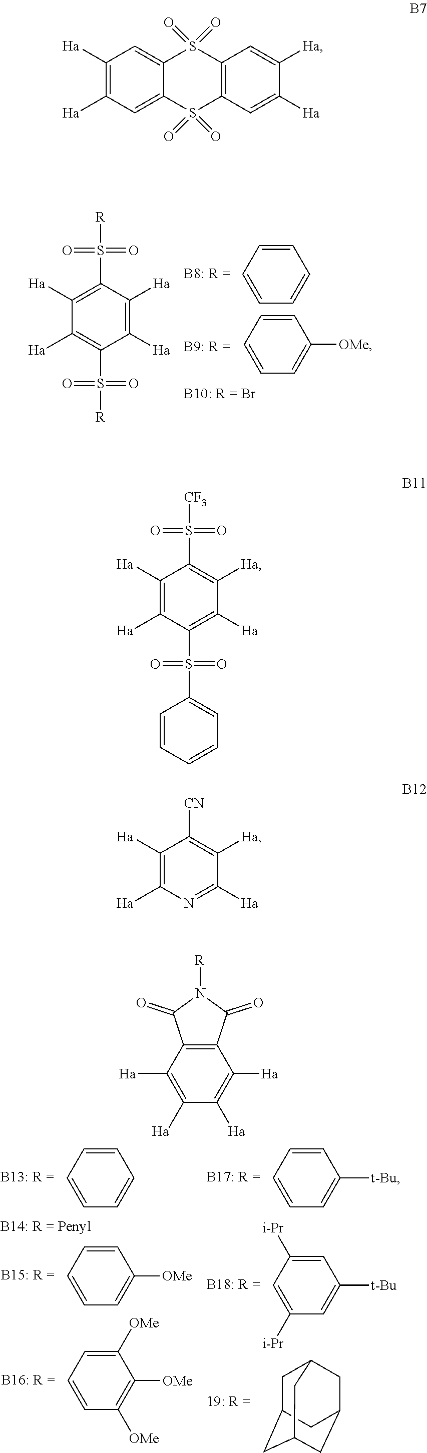

Here, Ha may include at least one halogen element selected from the group consisting of F, Cl, Br, and I.

Preferably, the PIM is prepared by condensation polymerization of monomer A represented by Chemical Formula 2 below and monomer B represented by Chemical Formula 3 below.

Monomer A may be represented by Chemical Formula 2 below.

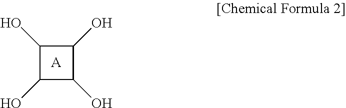

Here, A may include at least one selected from the group consisting of

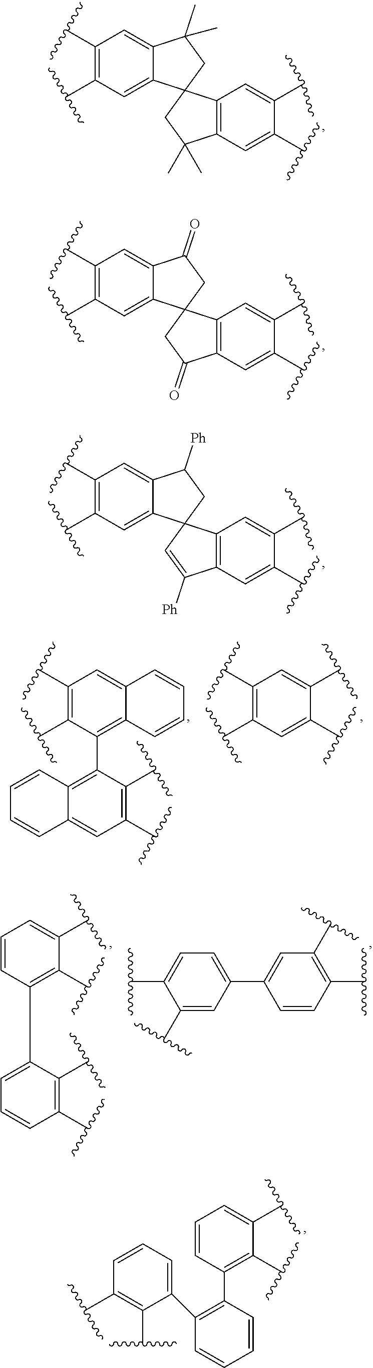

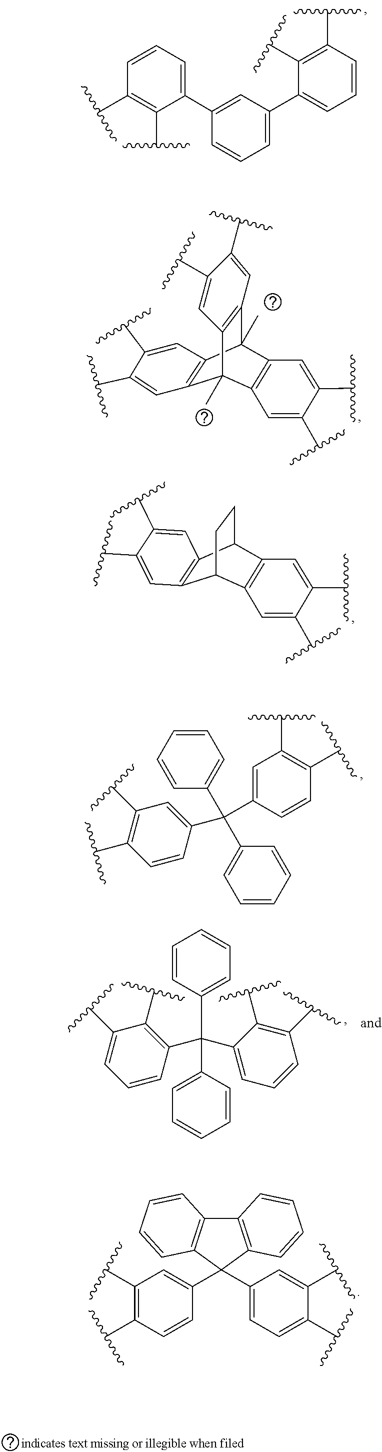

Monomer B may be represented by Chemical Formula 3 below.

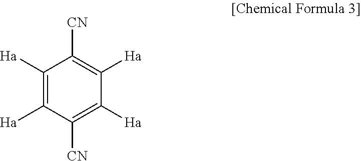

Here, Ha may include at least one halogen element selected from the group consisting of F, Cl, Br, and I.

Condensation reaction of monomers A and B may be performed by a conventionally known method and is not particularly limited.

In one embodiment, the coating layer 220 may include a porous polymer having a number average molecular weight (Mn) of 5,000 to 100,000 g/mol. If the number average molecular weight of the porous polymer is less than 5,000, mobility may become excessively high, making it difficult to properly fix the porous polymer to the surface of the catalyst. On the other hand, if the number average molecular weight of the porous polymer exceeds 100,000, permeability of materials such as water, oxygen, and protons may decrease, and activity of the catalyst may deteriorate. Preferably, the number average molecular weight of the porous polymer is 5,000 to 55,000 g/mol.

In one embodiment, the weight ratio of the catalyst complex to the porous polymer in the coating layer 220 may be 100:3 to 100:20. If the weight ratio of the catalyst complex to the porous polymer is less than 100:3, the amount of the porous polymer relative to the catalyst complex may be too small, so that the porous polymer may not be properly applied onto the surface of the catalytic metal 212. On the other hand, if the weight ratio of the catalyst complex to the porous polymer in the coating layer 220 exceeds 100:20, the porous polymer may be applied even onto the surface of the support 211 beyond the surface of the catalytic metal 212 in the catalyst complex. In this case, activity of the catalyst complex may deteriorate.

In one embodiment, the thickness of the coating layer 220 may be 0.1 nm to 5 nm. If the thickness of the coating layer 220 is less than 0.1 nm, the amount of the porous polymer with which the catalytic metal 212 is coated may be too small, so that effects of preventing ionomer poisoning and increasing catalytic activity may not be fully exerted. On the other hand, if the thickness of the coating layer 220 exceeds 5 nm, permeability of materials such as water, oxygen, and protons may decrease, and activity of the catalyst may deteriorate.

Meanwhile, FIG. 2 shows a membrane-electrode assembly according to the present disclosure. A membrane-electrode assembly according to another embodiment of the present disclosure may include an electrolyte membrane 30, a cathode 10 formed on one side of the electrolyte membrane 30, and an anode 20 formed on the other side of the electrolyte membrane 30, and at least one of the cathode 10 or the anode 20 may include the electrode described above.

The anode 20 is an electrode that receives fuel such as hydrogen gas to thus separate hydrogen into protons and electrons by hydrogen oxidation reaction (HOR) and is also referred to as a fuel electrode.

At the cathode 10, power and heat are generated by oxygen reduction reaction (ORR) of protons moving from the anode 20 through the electrolyte membrane 30, electrons supplied from an external circuit, and oxygen gas supplied from the outside, and simultaneously water is generated as a reaction byproduct.

In the membrane-electrode assembly according to the present disclosure, the electrode according to the present disclosure may be used as the anode 20 and/or the cathode 10, thereby obtaining a fuel cell having excellent electrochemical performance and durability.

In addition, the electrolyte membrane 30 may be used without particular limitation, so long as it is commonly used in the art. For example, a polymer (ionomer) with proton conductivity such as Nafion may be used. Also, an electrolyte membrane 30 in which a reinforced membrane such as e-PTFE (expanded-polytetrafluoroethylene) is impregnated with the ionomer may be used.

A method of manufacturing an electrode for a fuel cell according to the present disclosure may include preparing a catalyst complex including a support 211 and a catalytic metal 212 and a porous polymer, manufacturing an electrode catalyst having a core-shell structure by coating at least a portion of the surface of the catalytic metal 212 with the porous polymer, preparing a slurry by adding the electrode catalyst to an electrode binder, and forming an electrode by applying the slurry onto a substrate.

The porous polymer may be prepared by condensation polymerization of at least one of monomers A1 to A18 (monomer group A) and at least one of monomers B1 to B19 (monomer group B) as described above. Preferably, the porous polymer is prepared by condensation polymerization of monomer A represented by Chemical Formula 2 and monomer B represented by Chemical Formula 3. Condensation reaction between monomer group A and monomer group B may be performed by a conventionally known method and is not particularly limited.

For example, the porous polymer may be obtained by mixing monomer group A, monomer group B, and potassium carbonate (K₂CO₃) under stirring.

More specifically, monomer group A, monomer group B, and potassium carbonate (K₂CO₃) are placed in a round-bottom flask, a reflux condenser is connected thereto, and then the flask is filled with nitrogen or argon gas. Heating is performed at 140 to 180° C. for 0.5 to 8 hours with stirring. After completion of reaction, the temperature is lowered to 25° C. followed by precipitation in an organic solvent including methanol or ethanol. Re-precipitation is repeated 1 to 3 times using the same organic solvent followed by drying in a vacuum oven at 60 to 100° C. for 20 to 28 hours, thereby obtaining a polymer of intrinsic microporosity (PIM).

In one embodiment, manufacturing the electrode catalyst 200 may include adding the catalyst complex and the porous polymer to a solvent followed by mixing, precipitating and recovering the electrode catalyst 200 by pouring an aqueous solvent into the mixture, and drying the recovered electrode catalyst 200.

Meanwhile, unless described otherwise herein, the structure, composition, amount, and the like of the porous polymer, the electrode catalyst 200, etc. are substantially the same as those described above, so a description thereof is omitted.

A better understanding of the present disclosure may be obtained through the following examples and comparative example. However, these examples are not to be construed as limiting the technical spirit of the present disclosure.

### Preparation Example—Preparation of Electrode Catalyst

### Preparation Example 1—10 g of Pt/C+1 g of PIM-1 (C)

A polymer of intrinsic microporosity (PIM-1) was prepared through the following reaction scheme, more specifically, by adding 5,5′,6,6′-tetrahydroxy-3,3,3′,3′-tetramethylspirobisindane (TTSBI), 2,3,5,6-tetrafluoroterephthalonitrile (TFTPN), and potassium carbonate (K₂CO₃) to dimethylformamide (DMF) with stirring. Here, condensation reaction between SBI and TFTPN was performed using a conventionally known method.

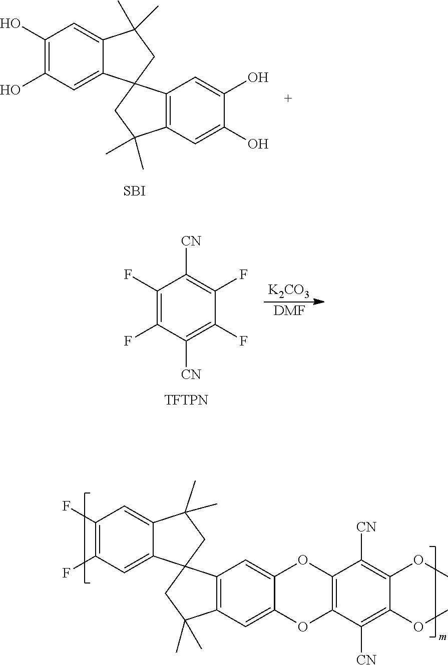

As such, PIM-1 (C) was prepared by appropriately adjusting the repeat unit m of the formula so that the number average molecular weight (Mn) was about 15,000 g/mol.

A mixture was prepared by adding 1 g of PIM-1 (C) prepared above and 10 g of a Pt/C catalyst complex in which a platinum catalyst is supported on a carbon support to N-methylpyrrolidone (NMP) as an organic solvent. Thereafter, the mixture was placed in a bead mill and then milled at 500 rpm for 2 hours, thus coating the surface of the platinum catalyst with the porous polymer.

Water was poured into the mixture in which the electrode catalyst was dispersed to precipitate the electrode catalyst, followed by centrifugation to recover the electrode catalyst. Subsequently, the recovered electrode catalyst was dried in a vacuum oven, thereby obtaining an electrode catalyst according to Preparation Example 1.

### Preparation Example 2—10 g of PI/C+2 g of PIM-1 (A)

An electrode catalyst having a core-shell structure according to Preparation Example 2 was manufactured in the same manner as in Preparation Example 1, with the exception that PIM-1 (A) having a number average molecular weight (Mn) of about 50,000 g/mol was prepared as a polymer of intrinsic microporosity and was added in an amount of 2 g to NMP as an organic solvent.

### Preparation Example 3—10 g of Pt/C+1 g of PIM-1 (A)

An electrode catalyst having a core-shell structure according to Preparation Example 3 was manufactured in the same manner as in Preparation Example 2, with the exception that 1 g of PIM-1 (A) was added to NMP as an organic solvent.

Meanwhile, the actual number average molecular weight (Mn), weight average molecular weight (Mw), and polydispersity index (PDI) of PIM-1 (A) and PIM-1 (C) synthesized in Preparation Examples 1 to 3 are as shown in Table 1 below.

TABLE 1

| | Mn | Mw | |
|---|---|---|---|
| | (g/mol) | (g/mol) | PDI |
| PIM-1(A) | 15028 | 31409 | 2.09 |
| PIM-1(C) | 52848 | 87556 | 1.66 |

### Test Example 1

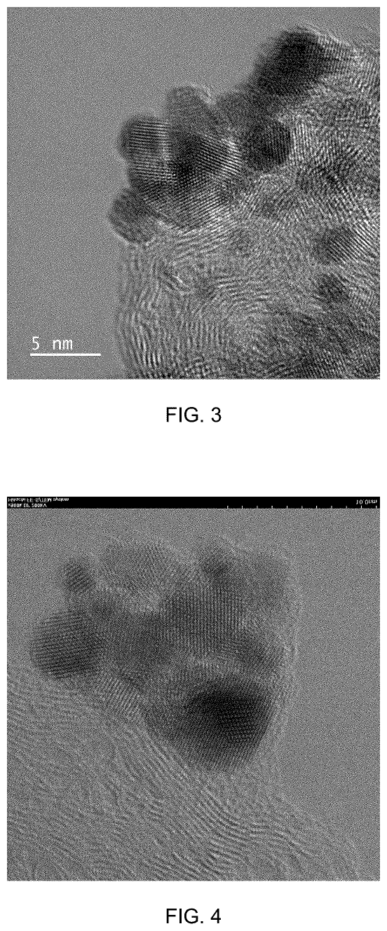

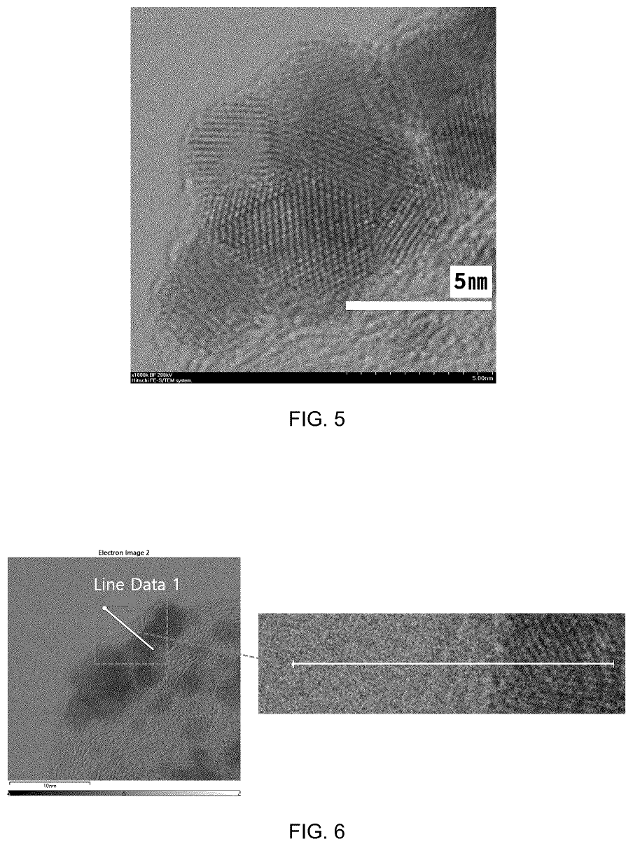

In order to confirm the structure and composition of the manufactured electrode catalysts, the electrode catalysts according to Preparation Examples 1 to 3 were analyzed using a transmission electron microscope (TEM). Respective results thereof are shown in FIGS. 3 to 5.

Referring to FIGS. 3 to 5, all the electrode catalysts synthesized by the method according to the present disclosure had a core-shell structure. Also, the thickness of the coating layer was determined to be about 0.1 nm to 5 nm.

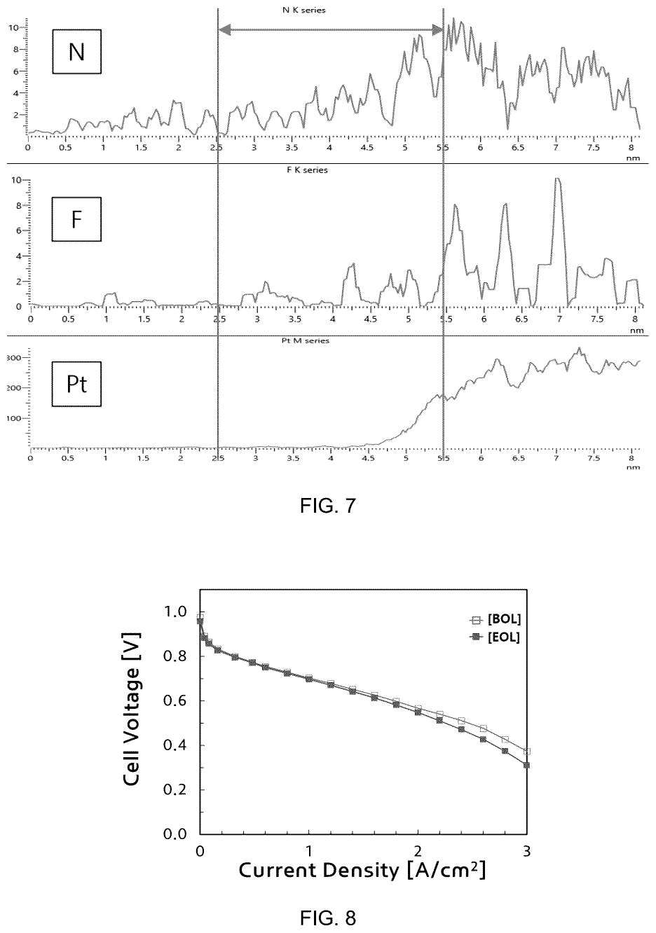

Also, in order to confirm the composition of the metal catalyst and the coating layer formed on the surface thereof, the electrode catalyst according to Preparation Example 1 was line scanned using energy dispersive spectroscopy (EDS) as shown in FIG. 6, and the results thereof are shown in FIG. 7.

Referring to the results in FIG. 7, nitrogen and fluorine were detected. This is deemed to be derived from the —CN group and —F group contained in PIM-1 (C). Therefore, the coating layer of the electrode catalyst manufactured according to the present disclosure was confirmed to include the porous polymer.

### Example—Manufacture of Membrane-Electrode Assembly

### Example 1—Use of Preparation Example 1

An electrode slurry was prepared by adding the electrode catalyst according to Preparation Example 1 and Nafion (D2021) as an electrode binder to a mixed solvent of 100 g of NPA (n-propyl alcohol) and 100 g of water. Here, the weight ratio of the electrode catalyst to the electrode binder was set so that the weight of the carbon support in the electrode catalyst and the weight of the Nafion were 1:1.

Also, an anode slurry was prepared by adding a Pt/C catalyst and Nafion (D2021) as an electrode binder to the mixed solvent. As such, the weight ratio of the Pt/C catalyst to the electrode binder was set so that the weight of the carbon support of the Pt/C catalyst and the weight of the Nafion were 1:1.

The electrode slurry was applied onto one side of known Nafion (211) as an electrolyte membrane, and the anode slurry was applied onto the other side thereof, followed by drying and heat treatment, thereby manufacturing a membrane-electrode assembly including a cathode (the electrode slurry), an anode, and an electrolyte membrane disposed therebetween. As such, the catalyst loading on the cathode was set to 0.4 mgpₜ/cm², and the catalyst loading on the anode was set to 0.05 mgpₜ/cm².

### Example 2—Use of Preparation Example 2

A membrane-electrode assembly was manufactured in the same manner as in Example 1, with the exception that, in the process of manufacturing the membrane-electrode assembly, the electrode catalyst according to Preparation Example 2 was used, and the catalyst loading on the cathode was set to 0.15 mgpₜ/cm².

### Comparative Example—Use of Known Pt/C Catalyst

A membrane-electrode assembly was manufactured in the same manner as in Example 1, with the exception that, in the process of manufacturing the electrode slurry for use in a cathode, a known Pt/C catalyst not including a porous polymer was used instead of the electrode catalyst according to Preparation Example 1.

### Test Example 2—Verification of Electrochemical Performance of Membrane-Electrode Assembly

In order to verify performance of the membrane-electrode assemblies according to Example 1, Example 2, and Comparative Example, a unit cell was manufactured by fastening the manufactured membrane-electrode assembly at a pressure of 100 in*lb using a gasket made of Teflon and a bipolar plate made of carbon, after which an accelerated degradation test (ADT) was performed under the following conditions.

The conditions of ADT were 0.6 V-0.95 V square wave 3 seconds, 10,000 times; environmental conditions: RH 100%, 80° C., 3.0 bara, AN: hydrogen 42 sccm, CA: nitrogen 134 sccm.

The results of Example 1 are shown in Table 2 below and FIG. 8, and the results of Comparative Example 1 are shown in Table 3 below.

TABLE 2

| | 80° C., RH20%, 3.0 barₐ | | |
|---|---|---|---|
| Current | BOL | | Performance |
| density | (beginning | EOL | degradation |
| (A/cm²) | of life) | (End of life) | rate |
| 0.08 | 0.865 V | 0.857 V | 0.96% |
| 1.0 | 0.703 V | 0.697 V | 0.95% |
| 2.0 | 0.567 V | 0.548 V | 3.45% |
| 3.0 | 0.374 V | 0.311 V | 16.83% |

TABLE 3

| | 80° C., RH20%, 3.0 barₐ | | |
|---|---|---|---|
| Current | BOL | | Performance |
| density | (beginning | EOL | degradation |
| (A/cm²) | of life) | (End of life) | rate |
| 0.08 | 0.864 V | 0.829 V | 4.05% |
| 1.0 | 0.669 V | 0.616 V | 7.92% |
| 2.0 | 0.524 V | 0.443 V | 15.45% |
| 3.0 | — | — | — |

Referring to Tables 2 and 3, Example 1, in which the electrode catalyst having the porous polymer coating layer according to the present disclosure was used as an electrode, exhibited a much lower performance degradation rate than Comparative Example.

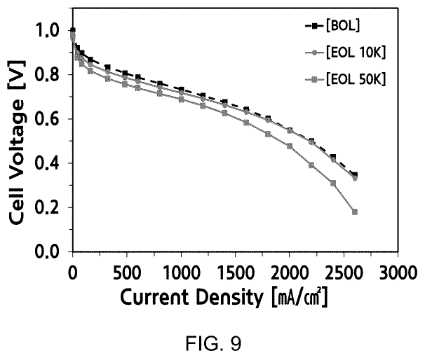

Also, the accelerated degradation test of the unit cell was performed on Example 2 under the following conditions. The results thereof are shown in Table 4 below and FIG. 9.

The conditions of ADT are 0.6 V-0.95 V square wave 3 seconds, 10,000 times and 50,000 times; environmental conditions: RH 100%, 60° C., 2.5 bara, AN: hydrogen 42 sccm, CA: nitrogen 134 sccm.

TABLE 4

| | 60° C., RH50%, 2.0 barₐ | | | | |
|---|---|---|---|---|---|
| Current | | | Performance | | Performance |
| density | | EOL | degradation | EOL | degradation |
| (A/cm²) | BOL | (10K) | rate | (50K) | rate |
| 0.08 | 0.898 V | 0.876 V | 2.45% | 0.849 | 5.46% |
| 1.0 | 0.733 V | 0.718 V | 2.05% | 0.688 | 6.14% |
| 2.0 | 0.550 V | 0.548 V | 0.36% | 0.477 | 13.27% |
| 3.0 | — | — | — | | |

Referring to the results of Table 4 and FIG. 9, Example 2 exhibited a low performance degradation rate of 3% or less even when the accelerated degradation test was repeated 10k times. Also, in Example 2, even when the accelerated degradation test was repeated 50k times, the performance degradation rate was similar to that of Comparative Example 1 in which such a test was repeated only 10k times.

As is apparent from the foregoing, an electrode for a fuel cell according to the present disclosure can effectively protect a catalyst from a catalyst poisoning agent in an oxidizing electrochemical environment due to use of an electrode catalyst including a catalyst complex having a catalytic metal supported on a support and a coating layer formed by coating at least a portion of the surface of the catalytic metal with a porous polymer.

Moreover, high oxygen permeability and proton transportability can be maintained by virtue of the porous polymer. Furthermore, the porous polymer has high affinity for the catalytic metal of the core and can be uniformly applied onto the surface of the catalytic metal.

In addition, a method of manufacturing an electrode for a fuel cell according to the present disclosure enables uniform coating of the surface of a catalytic metal with a coating layer including the porous polymer without performing a separate air etching process, etc.

The effects of the present disclosure are not limited to the foregoing. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. An electrode for a fuel cell, the electrode comprising:
an electrode binder; and
an electrode catalyst admixed with the electrode binder,
wherein the electrode catalyst comprises:
a catalyst complex including a catalytic metal supported on a support; and
a coating layer of a porous polymer on at least a portion of a surface of the catalytic metal.

2. The electrode of claim 1, wherein the electrode binder comprises a perfluorinated sulfonic acid polymer.

3. The electrode of claim 1, wherein the catalytic metal comprises one or more of platinum, palladium, cobalt, gold, ruthenium, tin, molybdenum, rhodium, iridium, bismuth, copper, yttrium, and chromium.

4. The electrode of claim 1, wherein the support comprises a carbon-based support, and the carbon-based support comprises one or more of carbon black, carbon nanotubes, graphite, and graphene.

5. The electrode of claim 1, wherein the porous polymer comprises a polymer of intrinsic microporosity (PIM).

6. The electrode of claim 1, wherein the porous polymer comprises a copolymer of any one of monomers A1 to A18 below and any one of monomers B1 to B19 below: 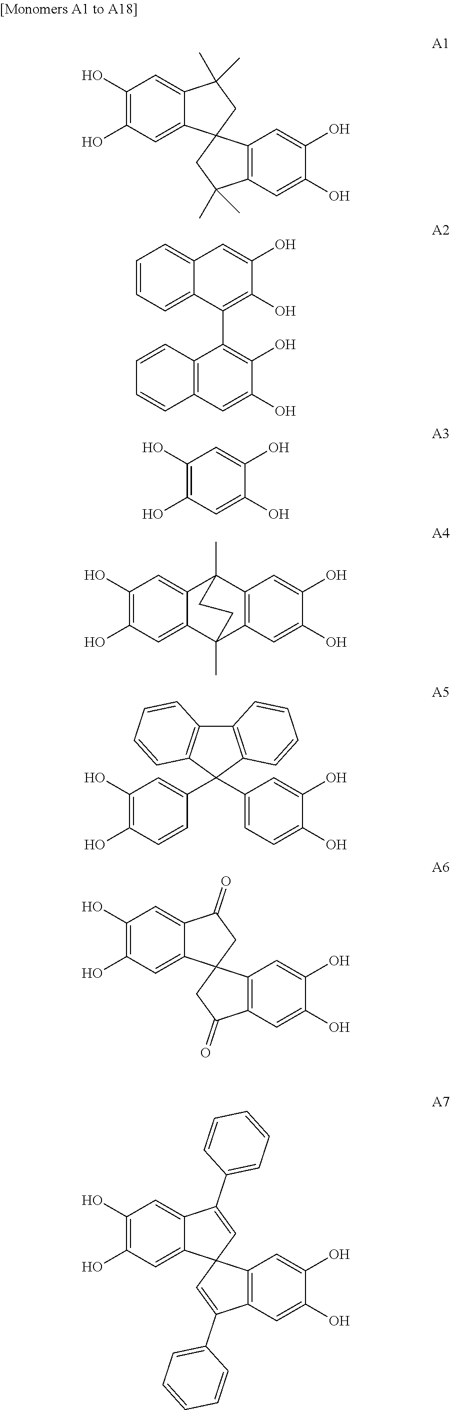 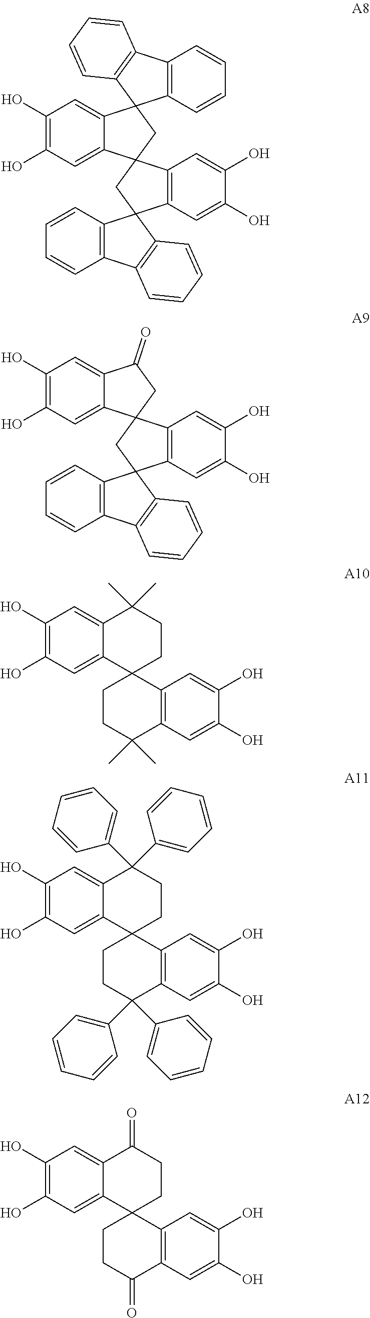 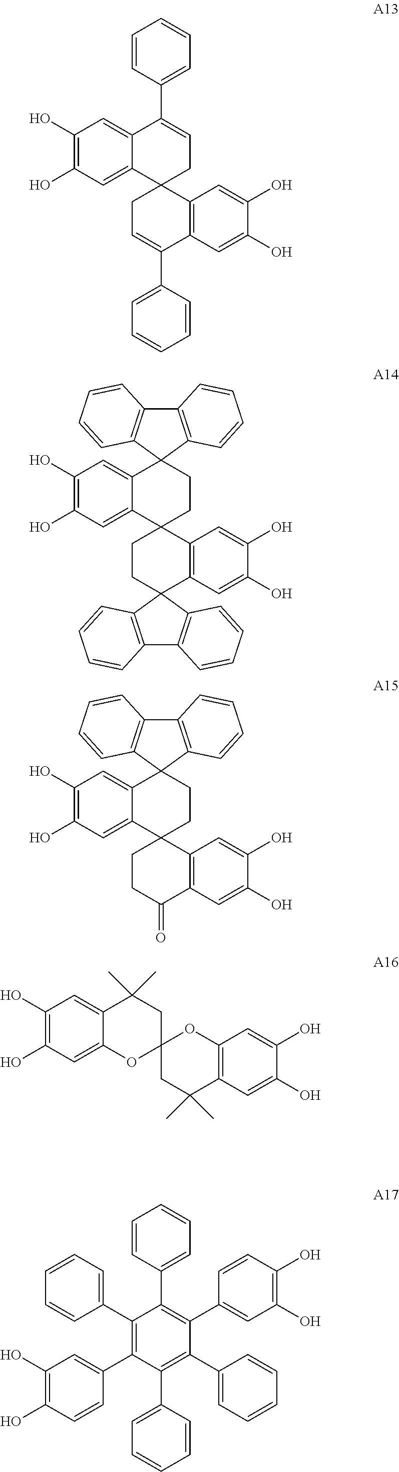 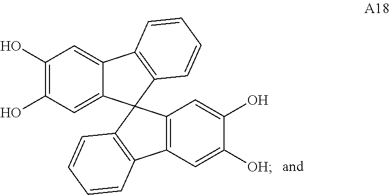 [SMILES: Oc1cc2c(cc1O)C1(c3ccccc3-2)c2ccccc2-c2cc(O)c(O)cc21] 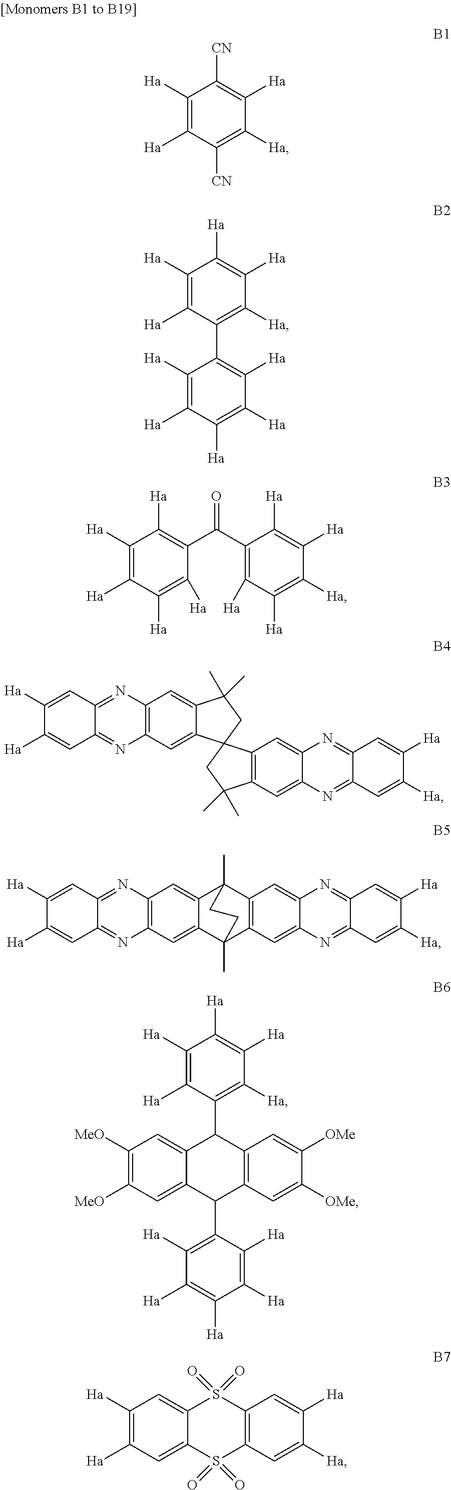 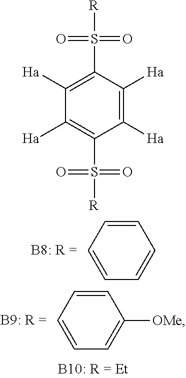 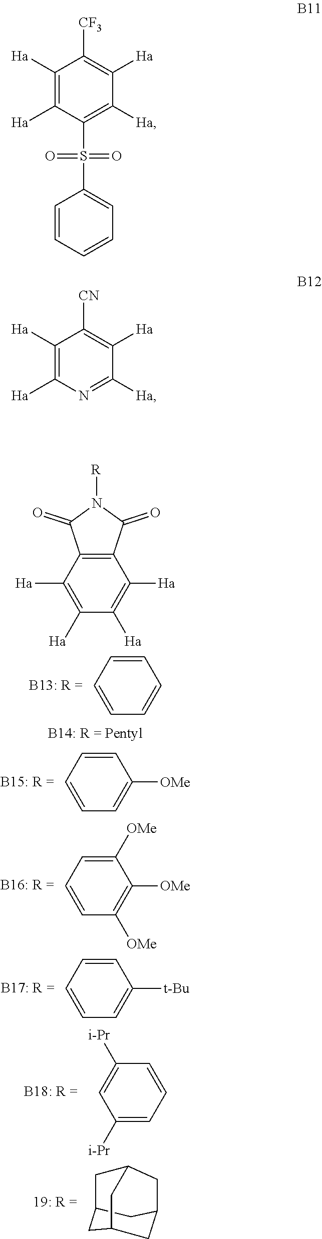
wherein Ha comprises one or more of F, Cl, Br, and I.

7. The electrode of claim 1, wherein the porous polymer is represented by Chemical Formula 1 below: 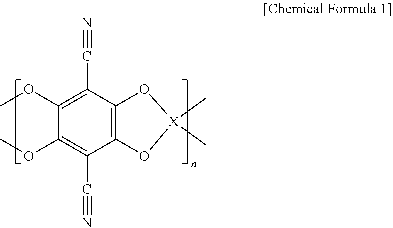
wherein X comprises one or more of 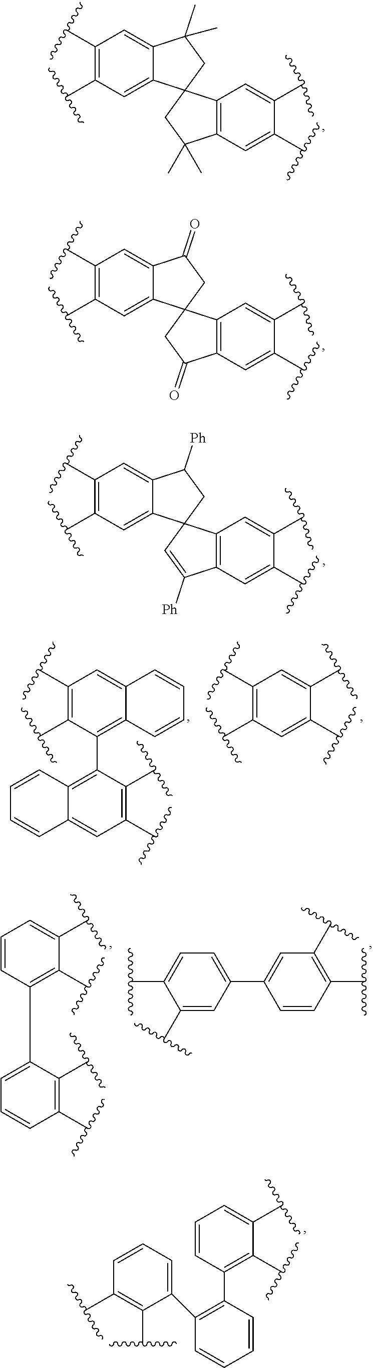 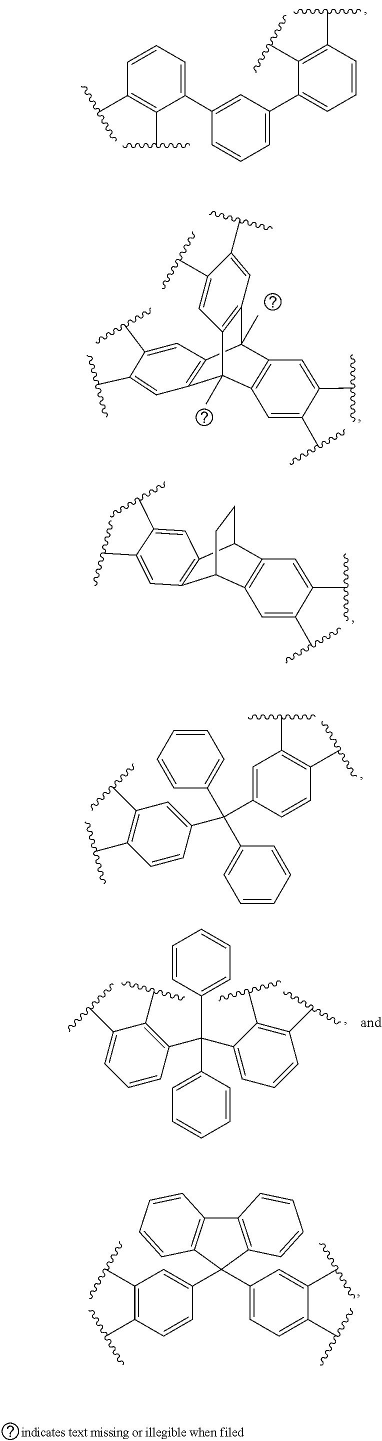
and
n is an integer from 1 to 10.

8. The electrode of claim 1, wherein the coating layer comprises a porous polymer having a number average molecular weight (Mn) of about 5,000 to 100,000.

9. The electrode of claim 1, wherein a weight ratio of the catalyst complex to the porous polymer in the coating layer is about 100:3 to 100:20.

10. The electrode of claim 1, wherein a thickness of the coating layer is about 0.1 nm to 5 nm.

11. A membrane-electrode assembly comprising:
an electrolyte membrane;
a cathode formed on one side of the electrolyte membrane; and
an anode formed on the other side of the electrolyte membrane,
wherein at least one of the cathode and the anode comprises the electrode of claim 1.

12. A method of manufacturing an electrode for a fuel cell, the method comprising:
preparing a catalyst complex comprising a support, a catalytic metal and a porous polymer;
manufacturing an electrode catalyst with a core-shell structure by coating at least a portion of a surface of the catalytic metal with the porous polymer;
preparing a slurry by combining the electrode catalyst with an electrode binder; and
forming an electrode by applying the slurry onto a substrate.

13. The method of claim 12, wherein manufacturing the electrode catalyst comprises:
adding the catalyst complex and the porous polymer to a solvent followed by mixing;
precipitating and recovering the electrode catalyst by pouring an aqueous solvent into a mixture; and
drying the recovered electrode catalyst.

14. The method of claim 12, wherein the catalytic metal comprises one or more of platinum, palladium, cobalt, gold, ruthenium, tin, molybdenum, rhodium, iridium, bismuth, copper, yttrium, and chromium, and combinations thereof.

15. The method of claim 12, wherein the porous polymer comprises a polymer of intrinsic microporosity (PIM).

16. The method of claim 12, wherein the porous polymer comprises a copolymer of at least one of monomers A1 to A18 below and at least one of monomers B1 to B19 below: 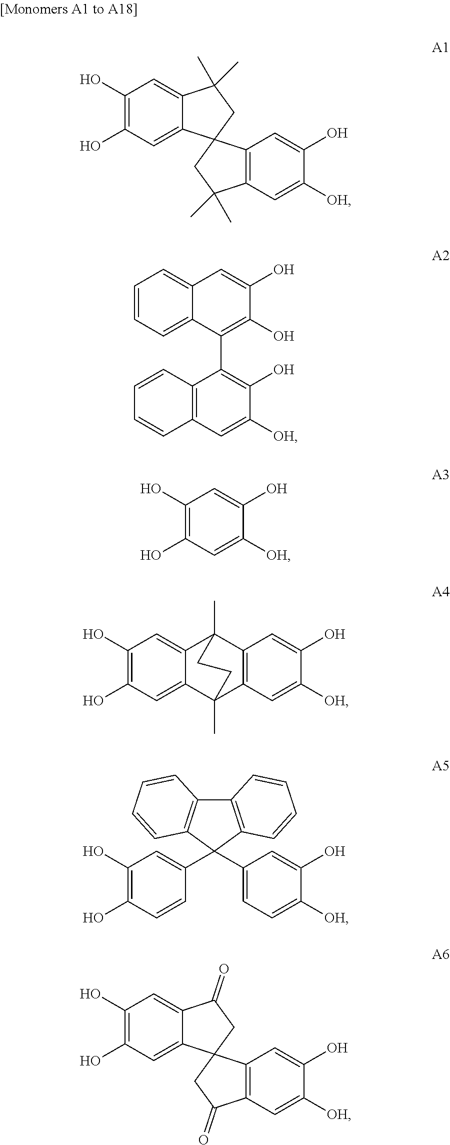 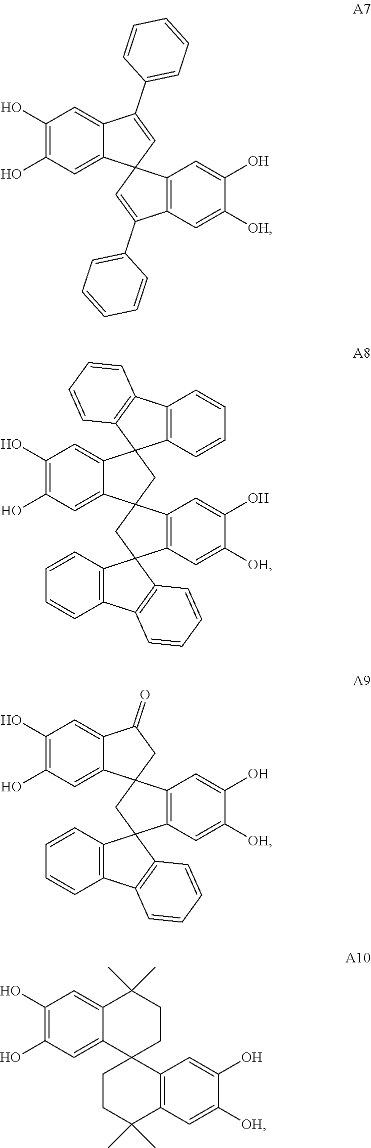 [SMILES: Oc1cc2c(cc1O)C1(C=C2c2ccccc2)C=C(c2ccccc2)c2cc(O)c(O)cc21 ; Oc1cc2c(cc1O)C1(CC23CC2(c4ccccc4-c4ccccc42)c2cc(O)c(O)cc23)c2ccccc2-c2ccccc21 ; O=C1CC2(CC3(c4ccccc4-c4ccccc43)c3cc(O)c(O)cc32)c2cc(O)c(O)cc21 ; CC1(C)CCC2(CCC(C)(C)c3cc(O)c(O)cc32)c2cc(O)c(O)cc21] 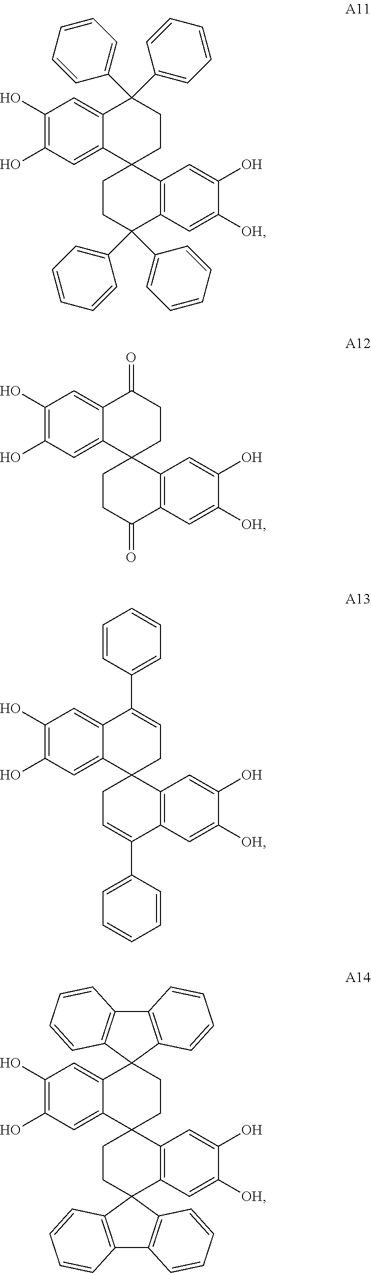 [SMILES: Oc1cc2c(cc1O)C(c1ccccc1)(c1ccccc1)CCC21CCC(c2ccccc2)(c2ccccc2)c2cc(O)c(O)cc21 ; O=C1CCC2(CCC(=O)c3cc(O)c(O)cc32)c2cc(O)c(O)cc21 ; Oc1cc2c(cc1O)C1(CC=C2c2ccccc2)CC=C(c2ccccc2)c2cc(O)c(O)cc21 ; Oc1cc2c(cc1O)C1(CCC23CCC2(c4ccccc4-c4ccccc42)c2cc(O)c(O)cc23)c2ccccc2-c2ccccc21] 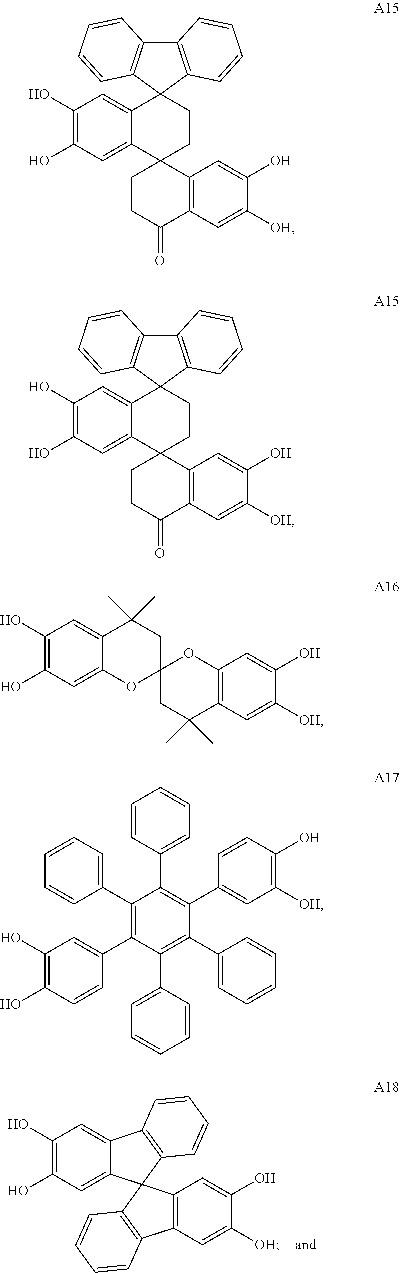 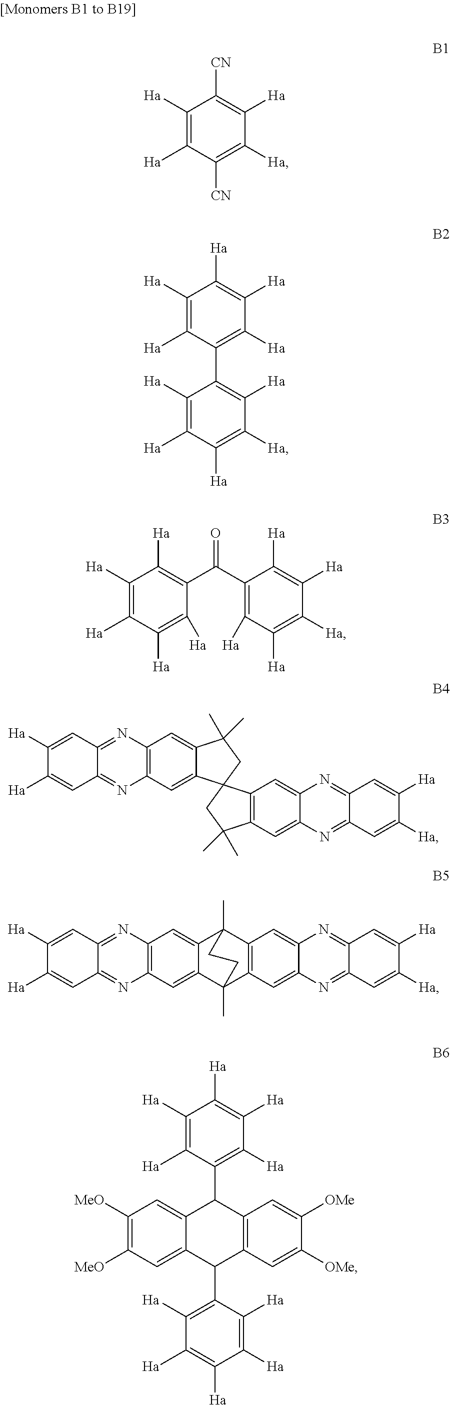 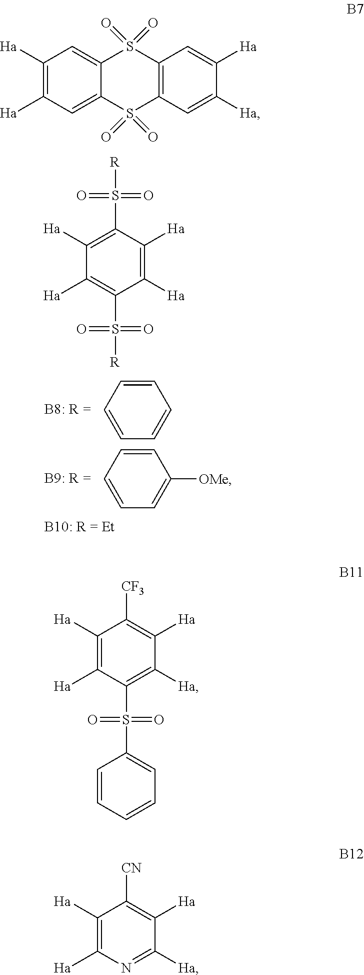 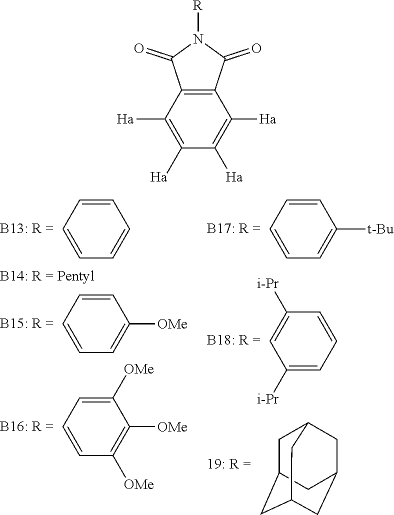
wherein Ha comprises one or more of F, Cl, Br, and I.

17. The method of claim 12, wherein the porous polymer is represented by Chemical Formula 1 below: 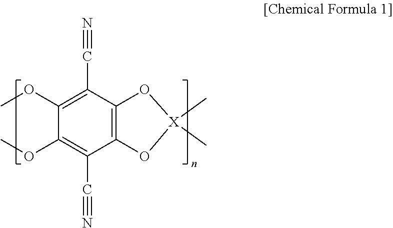
wherein X comprises one or more of 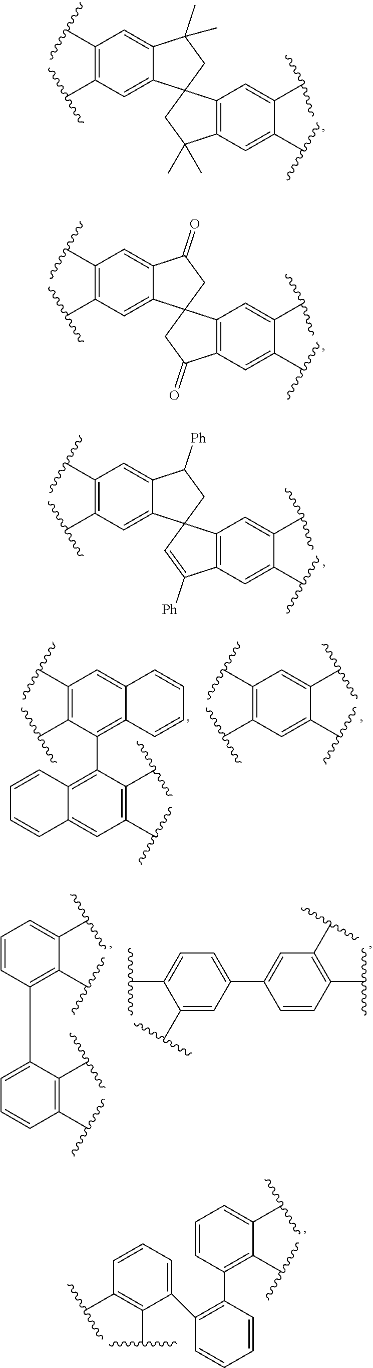 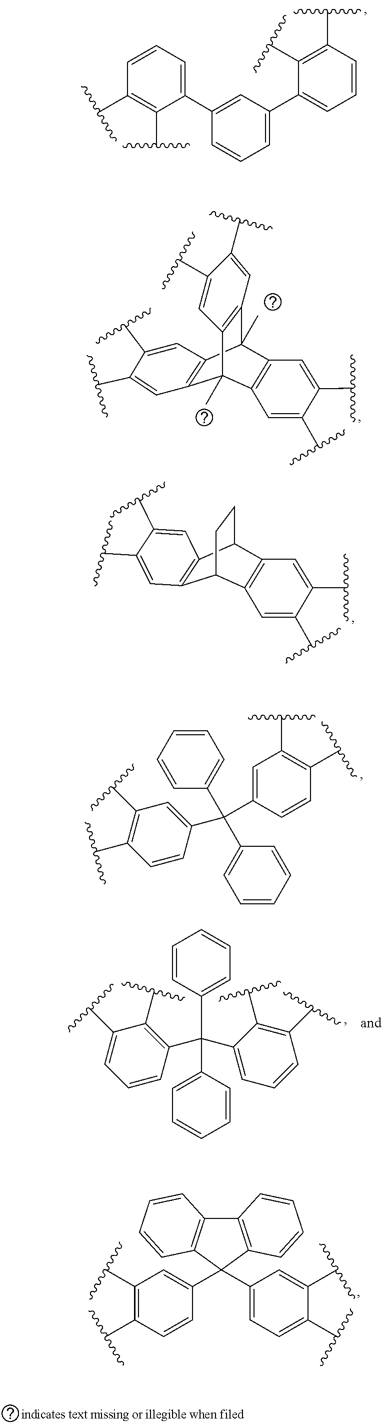
and
n is an integer from 1 to 10.

18. The method of claim 12, wherein the coating layer comprises a porous polymer having a number average molecular weight (Mn) of about 5,000 to 100,000.

19. The method of claim 12, wherein a weight ratio of the catalyst complex to the porous polymer is about 100:3 to 100:20.

20. The method of claim 12, wherein a thickness of the coating layer is about 0.1 nm to 5 nm.
